(19) United States
(12) Patent Application Publication
(10) Pub. No.: US 2024/0338393 A1
(43) Pub. Date: Oct. 10, 2024

(54) INTERACTIVE SEMANTIC DOCUMENT MAPPING AND NAVIGATION WITH MEANING-BASED FEATURES

(71) Applicant: NEC Laboratories America, Inc., Princeton, NJ (US)

(72) Inventors: Christopher Malon, Fort Lee, NJ (US); Iain Melvin, Princeton, NJ (US); Christopher A. White, Neshanic Station, NJ (US)

(21) Appl. No.: 18/628,271

(22) Filed: Apr. 5, 2024

Related U.S. Application Data
(60) Provisional application No. 63/457,432, filed on Apr. 6, 2023.
(60) Provisional application No. 63/460,702, filed on Apr. 20, 2023.

(51) Int. Cl. G06F 16/332; G06F 16/338; G06F 40/30

(52) U.S. Cl. CPC G06F 16/3323; G06F 16/338; G06F 40/30

(57) ABSTRACT

Systems and methods are provided for analyzing and visualizing document corpuses based on user-defined semantic features, including initializing a Natural Language Inference (NLI) classification model pre-trained on a diverse linguistic dataset, analyzing a corpus of textual documents with semantic features described in natural language by a user. For each semantic feature, a classification process is executed using the NLI model to assess implication strength between sentences in the documents and the semantic feature, the classification process including a confidence scoring mechanism to quantify implication strength. Implication scores can be aggregated for each of the documents to form a composite semantic implication profile, and a dimensionality reduction technique, can be applied to the composite semantic implication profiles of each of the documents to generate a two-dimensional semantic space representation. The two-dimensional semantic space representation can be dynamically adjusted based on iterative user feedback regarding the accuracy of semantic implication assessments.

### RELATED APPLICATION INFORMATION

This application claims priority to U.S. Provisional App. No. 63/460,702, filed on Apr. 20, 2023, and U.S. Provisional App. No. 63/457,432, filed on Apr. 6, 2023, each incorporated herein by reference in its entirety.

### BACKGROUND

### Technical Field

The present invention relates to systems and methods for information retrieval and document analysis, and more particularly to interactive systems and methods that utilizes machine learning to dynamically organize and visualize documents based on user-defined semantic features for accurate and efficient information retrieval and analysis.

### Description of the Related Art

In the domain of web applications and interactive online platforms, conventional architectures predominantly utilize a static server-client model, where web servers process data and render HTML content to be displayed by client browsers. This model, while functional for basic web interactions, is inherently limited in its capacity to offer dynamic, real-time data processing and visualization, particularly in applications requiring on-the-fly generation and manipulation of machine learning representations. Traditional web applications lack the infrastructure to seamlessly integrate user feedback directly into the machine learning lifecycle or to dynamically adjust data representations in response to user interactions. Furthermore, the rigidity of server-client architectures makes it challenging to implement responsive, personalized user experiences that adapt to individual user actions and preferences. These limitations are particularly pronounced in scenarios demanding complex data analysis and visualization, such as in the fields of document clustering, semantic analysis, and personalized content recommendation. As a result, there exists a significant gap in the ability of web applications to provide interactive, intuitive platforms for data exploration and analysis, underscoring the necessity for an innovative approach that transcends the constraints of traditional server-client models and harnesses the power of machine learning in a user-centric, adaptive framework.

### SUMMARY

According to an aspect of the present invention, a method is provided for analyzing and visualizing document corpuses based on user-defined semantic features, including initializing a Natural Language Inference (NLI) classification model pre-trained on a diverse linguistic dataset, analyzing a corpus of textual documents with semantic features described in natural language by a user. For each semantic feature, a classification process is executed using the NLI model to assess implication strength between sentences in the documents and the semantic feature, the classification process including a confidence scoring mechanism to quantify implication strength. Implication scores can be aggregated for each of the documents to form a composite semantic implication profile, and a dimensionality reduction technique, can be applied to the composite semantic implication profiles of each of the documents to generate a two-dimensional semantic space representation. The two-dimensional semantic space representation can be dynamically adjusted based on iterative user feedback (e.g., qualitative and/or quantitative feedback) regarding the accuracy of semantic implication assessments.

According to another aspect of the present invention, a system is provided for analyzing and visualizing document corpuses based on user-defined semantic features for interactive, on-demand generation of machine learning representations within a web browser environment. A processor device coupled to a computer-readable storage medium can be utilized for activating a data processing pipeline designed to accept raw input data, including text and images, apply a series of machine learning-based transformations to generate vectorial representations of said data, and preprocess said data through normalization, tokenization, and feature extraction processes, instantiating and managing a plurality of data-centric micro-services, each micro-service dedicated to a distinct dataset or data type, capable of maintaining and manipulating in-memory representations of transformed data, and exposing a queryable application programming interface (API) for real-time data interaction and retrieval, creating user session models through user-centric threads, each thread capturing and responding to individual user interactions, feedback, and navigation patterns within the system to offer a tailored data exploration and manipulation experience, and provisioning a dynamic user interface, rendered within the web browser, to visualize machine learning representations, including document embeddings and statistical data models, allow for the direct manipulation of said representations by the user, and capture user feedback for iterative model refinement.

According to another aspect of the present invention, a non-transitory computer readable medium is provided for analyzing and visualizing document corpuses based on user-defined semantic features for interactive, on-demand generation of machine learning representations within a web browser environment. A pre-trained Natural Language Inference (NLI) model can be utilized to perform semantic analysis on a corpus of unstructured data along with a set of user-defined semantic features relevant to the user's domain of interest, identifying and classifying relationships between the data and the user-defined semantic features to generate preliminary semantic vectors for each data item. A dimensionality reduction algorithm is applied on the semantic vectors to produce a two-dimensional semantic embedding of the data, optimized for visual exploration and interpretation, and the two-dimensional semantic embedding can be rendered within an interactive, web-based visualization tool, enabling users to explore the semantic proximity between data items visually, select individual data items for detailed examination, and provide direct feedback on the semantic relevance of displayed relationships. User feedback is captured directly from the visualization tool, including adjustments to the positioning of data items within the embedding and textual annotations, and applying this feedback to iteratively refine the semantic vectors and the underlying NLI model for enhanced accuracy and relevance in subsequent analysis. The two-dimensional semantic embedding is dynamically updated based on the refined semantic vectors and re-rendering the updated embedding within the visualization tool for continuous user interaction and feedback.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustratively depicting an exemplary processing system to which the present invention may be applied, in accordance with embodiments of the present invention;

FIG. 2 is a diagram illustratively depicting a high-level view of an exemplary system and method for transforming and querying textual data across diverse datasets by converting raw text into structured, queryable information, in accordance with embodiments of the present invention;

FIG. 3 is a diagram illustratively depicting method for semantic analysis and iterative refinement of document corpuses through user engagement and machine learning techniques, in accordance with embodiments of the present invention;

FIG. 4 is a diagram illustratively depicting a system and method for interactive, dynamic document retrieval, analysis, and processing, including semantic feature extraction, document tokenization, and query ranking using integrated diverse document analysis tools within a centralized processing environment, in accordance with embodiments of the present invention;

FIG. 5 is a diagram illustratively depicting a method for interactive, dynamic document retrieval, analysis, and processing using a multi-stage approach for system setup, data handling, user-driven machine learning refinement, and ongoing system optimization, in accordance with embodiments of the present invention;

FIG. 6 is a diagram illustratively depicting a method for dynamic document analysis and visualization, integrating user-driven semantic feature input and interactive machine learning refinement, in accordance with embodiments of the present invention;

FIG. 7 is a block/flow diagram illustratively depicting a method for automated, machine learning-implemented semantic feature-based analysis and interactive visualization of legal documents for automatically generating recommendations (e.g., sentencing recommendations) in real-time, in accordance with embodiments of the present invention;

FIG. 8 is a diagram illustratively depicting a method for generating actionable insights and recommendations based on user-driven semantic feature definition, in-depth evaluation through few-shot debugging, and automated comparative analysis of documents based on refined semantic profiles, in accordance with aspects of the present invention;

FIG. 9 is a diagram illustratively depicting a method for dynamically initializing, analyzing, and visualizing document corpuses in real-time through user-guided semantic classification and dynamic feedback integration for optimized interactive document analysis, processing, and exploration, in accordance with aspects of the present invention;

FIG. 10 is a diagram illustratively depicting a system for dynamically initializing, analyzing, and visualizing document corpuses in real-time through user-guided semantic classification and dynamic feedback integration for optimized interactive document analysis, processing, and exploration, in accordance with aspects of the present invention; and

FIG. 11 is a diagram illustratively depicting a system and method for dynamically initializing, analyzing, and visualizing document corpuses in real-time in a courtroom environment through user-guided semantic classification and dynamic feedback integration for optimized interactive document analysis, processing, and exploration, in accordance with aspects of the present invention.

### DETAILED DESCRIPTION

In accordance with embodiments of the present invention, systems and methods are provided for sophisticated document analysis and visualization based on user-defined semantic features. This can include utilizing a Natural Language Inference (NLI) classification model, which can be pre-trained on an extensive and varied linguistic dataset. This model can be used for analyzing a corpus of textual documents, wherein each semantic feature described by users in natural language is subjected to a thorough classification process. This process not only determines the implication strength between sentences and the semantic feature but also employs a confidence scoring system to precisely quantify the strength of these implications. Each document's implication scores can be meticulously compiled to form a comprehensive semantic implication profile, upon which a dimensionality reduction technique is then applied. This generates an insightful two-dimensional semantic space representation, designed to be dynamically refined through iterative feedback from users, enhancing the accuracy and depth of semantic implication assessments.

Another aspect of the present invention introduces a responsive system for real-time analysis and visualization of document corpuses, tailored for interactive machine learning representation generation within web browsers. The system utilizes a processor device, in conjunction with a computer-readable storage medium, to activate an advanced data processing pipeline. This pipeline is adept at receiving raw input data, including both text and images, and transforming this data using sophisticated machine learning algorithms to create vectorial representations. The data undergoes a meticulous preprocessing regimen, including normalization, tokenization, and feature extraction. A network of data-centric micro-services, each dedicated to a specific dataset or data type, can then be instantiated. These micro-services sustain and manage in-memory data representations and offer a queryable API for agile interaction and data retrieval. Complementing this, user-centric threads capture and adapt to individual user interactions, feedback, and navigation within the system, delivering a custom data exploration experience. Additionally, a dynamic user interface within the web browser presents the machine learning representations, including document embeddings and statistical models. This interface not only displays data but also allows users to interact directly with the representations, thus facilitating user feedback incorporation for continuous model refinement and system evolution.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Aspects of the present invention are described below with reference to flowchart illustrations and/or block diagrams of methods, systems, and computer program products according to embodiments of the present invention. It is noted that each block of the flowcharts and/or block diagrams, and combinations of blocks in the flowcharts and/or block diagrams, may be implemented by computer program instructions.

The flowchart and block diagrams in the figures illustrate the architecture, functionality, and operation of possible implementations of systems, methods, and computer program products according to various embodiments of the present invention. Each block in the flowchart or block diagrams may represent a module, segment, or portion of code, which comprises one or more executable instructions for implementing the specified logical function(s), and in some alternative implementations of the present invention, the functions noted in the block may occur out of the order noted in the figures. For example, two blocks shown in succession may, in fact, be executed substantially concurrently, may sometimes be executed in reverse order, or may be executed in any other order, depending on the functionality of a particular embodiment.

It is also noted that each block of the block diagrams and/or flowchart illustration, and combinations of blocks in the block diagrams and/or flowchart illustration, can be implemented by specific purpose hardware systems that perform the specific functions/acts, or combinations of special purpose hardware and computer instructions according to the present principles.

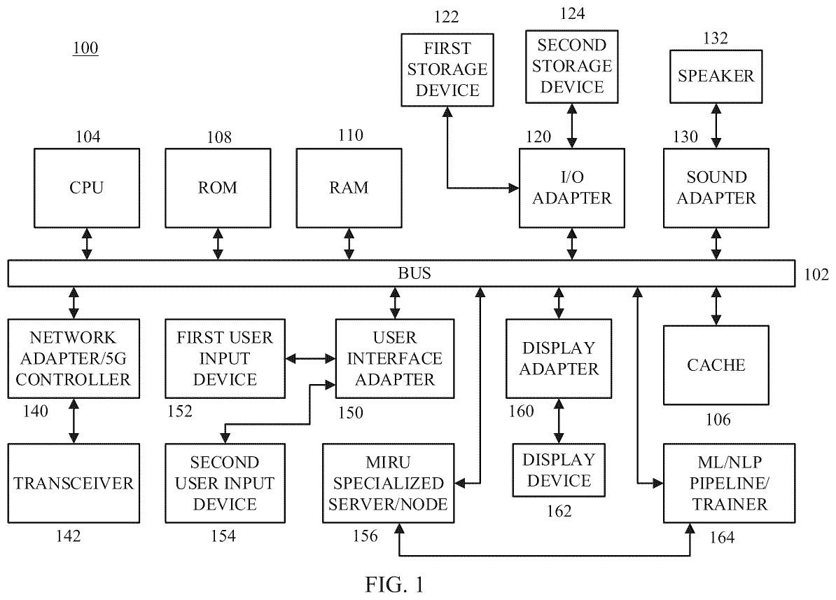

Referring now to the drawings in which like numerals represent the same or similar elements and initially to FIG. 1, an exemplary processing system 100, to which the present principles may be applied, is illustratively depicted in accordance with embodiments of the present principles.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. One or more video specialized servers/nodes 156 (e.g., MIRU Server Architecture, microservers, etc.) can be further coupled to system bus 102 by any appropriate connection system or method (e.g., Wi-Fi, wired, network adapter, etc.), in accordance with aspects of the present invention.

A first user input device 152 and a second user input device 154 are operatively coupled to system bus 102 by user interface adapter 150. The user input devices 152, 154 can be one or more of any of a keyboard, a mouse, a keypad, an image capture device, a motion sensing device, a microphone, a device incorporating the functionality of at least two of the preceding devices, and so forth. One or more video specialized servers/nodes 156 can be included, and can include one or more storage devices, communication/networking devices (e.g., WiFi, 4G, 5G, Wired connectivity), hardware processors, etc., in accordance with aspects of the present invention. In various embodiments, other types of input devices can also be used, while maintaining the spirit of the present principles. The user input devices 152, 154 can be the same type of user input device or different types of user input devices. The user input devices 152, 154 are used to input and output information to and from system 100, in accordance with aspects of the present invention. A specialized server/node 156 (e.g., MIRU) can process received input, and a Machine Learning (ML) Device/Natural Language Processor (NLP)/Neural Network (NN) Training Device 164 (e.g., neural network trainer) can be operatively connected to the system 100 for image analysis and matching, in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

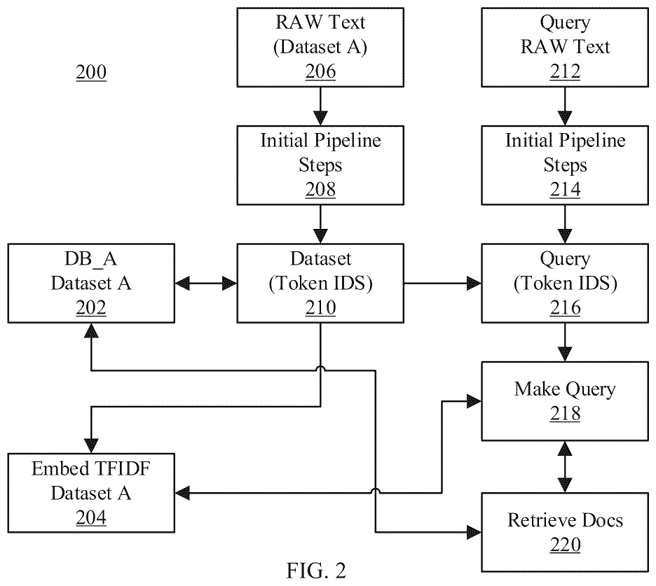

Moreover, it is to be appreciated that systems 200, 400, 1000, and 1100, described below with respect to FIGS. 2, 4, 10, and 11, respectively, are systems for implementing respective embodiments of the present invention. Part or all of processing system 100 may be implemented in one or more of the elements of systems 200, 400, 1000, and 1100, in accordance with aspects of the present invention.

Further, it is to be appreciated that processing system 100 may perform at least part of the methods described herein including, for example, at least part of methods 200, 300, 400, 500, 600, 700, 800, 900, and 1100, described below with respect to FIGS. 2, 3, 4, 5, 6, 7, 8, 9, and 11, respectively. Similarly, part or all of 200, 400, 1000, and 1100 may be used to perform at least part of methods 200, 300, 400, 500, 600, 700, 800, 900, and 1100 of FIGS. 2, 3, 4, 5, 6, 7, 8, 9, and 11, respectively, in accordance with aspects of the present invention.

As employed herein, the term “hardware processor subsystem,” “processor,” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor—or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Referring now to FIG. 2, a high-level view of an exemplary system and method 200 for transforming and querying textual data across diverse datasets by converting raw text into structured, queryable information, is illustratively depicted in accordance with embodiments of the present invention.

In various embodiments, in block 202, the system and method 200 can utilize a specialized system architecture (hereinafter interchangeably referred to as “MIRU”) that can take raw, unstructured text data, designated as Dataset A, and execute a complex transformation process. This data can be rigorously preprocessed, encompassing operations such as normalization to mitigate discrepancies in formatting, advanced tokenization to break the text into analyzable units, and stemming to reduce words to their root form. The resulting structured data is stored in ‘DB_A’, a specialized database tailored for quick retrieval and sophisticated linguistic analysis. ‘DB_A’ is architected to optimize data access patterns, featuring indices for rapid lookup and association of tokens with unique IDs, for utilization for efficient processing in subsequent stages.

In block 204, following the formation of ‘DB_A’, the MIRU system applies Term Frequency-Inverse Document Frequency (TF-IDF) embeddings to Dataset A. This involves a multifaceted statistical analysis where each word's relevance to a document is weighed against its frequency across the entire dataset. The system generates a multidimensional vector space where each document's representation reflects the significance of terms, capturing the essence of the document's thematic content. This embedding process is intricate, considering both the commonality of terms and their distinctive usage within individual documents, facilitating nuanced text analysis.

In block 206, Dataset A is subjected to the initial stages of a comprehensive NLP pipeline. This initial processing is an orchestration of several NLP techniques, applied in a sequence tailored to the nature of Dataset A. It involves parsing the text data through a series of linguistic filters and extractors, meticulously preparing it for conversion into a sequence of token IDs. This preparation is a bridge between raw text and its subsequent computational analysis, ensuring that every linguistic element is identified, contextualized, and ready for the embedding phase.

In block 208, the prepared text from Dataset A is now converted into a sequence of token IDs. Each token, a distilled representation of a word or a linguistic unit, is associated with a unique identifier, which is a direct reference to the ‘DB_A’ database entries. This assignment of token IDs is a methodical process that not only tags but also catalogs the tokens for swift retrieval and cross-referencing with other datasets or queries, which can harmonize the text data with the system's internal processing language, in accordance with aspects of the present invention.

In block 210, complex queries articulated through token IDs can be addressed. Leveraging the standardized format of token IDs, the MIRU system aligns the user's search intent with the pre-processed and tokenized Dataset A. Queries can be translated into a language of token IDs, enabling a seamless, efficient, and accurate matching process that utilizes the full spectrum of TF-IDF metrics. In block 212, the system receives a raw text query from the user. This entry point for user interaction captures the information need or search objective in the user's natural language. The reception of this query is the initiation of a dialogue between the user and the system, where the user's informational desires are expressed in raw, unstructured text form. In block 214, the raw query text can be processed using a parallel set of initial steps to those applied to Dataset A, ensuring the user's query is in sync with the dataset. The system can process the query with precision, employing tokenization and other NLP steps to transform the natural language query into a format that mirrors the structured, tokenized representation of Dataset A.

In block 216, the tokenized query can be further refined, mapping its contents to the token IDs used within ‘DB_A’. This translation step ensures that the user's query is rendered into the system's internal language of tokens, allowing for an accurate and contextualized search within the database. In block 218, armed with the token ID-rendered query, a search can be conducted against the Embed TFIDF service, a repository of TF-IDF matrices for Dataset A. This execution is an analytical operation where the query is sifted through the dataset, identifying and ranking documents based on their term relevance and contextual significance. In block 220, documents aligned with the query's semantic criteria are retrieved from ‘DB_A’. This retrieval is followed by a meticulous ranking process, orchestrated by the system to sort documents in order of relevance based on their TF-IDF scores. The outcome is a curated list of documents, each associated with metadata and contextual information, presented to the user to fulfill their query.

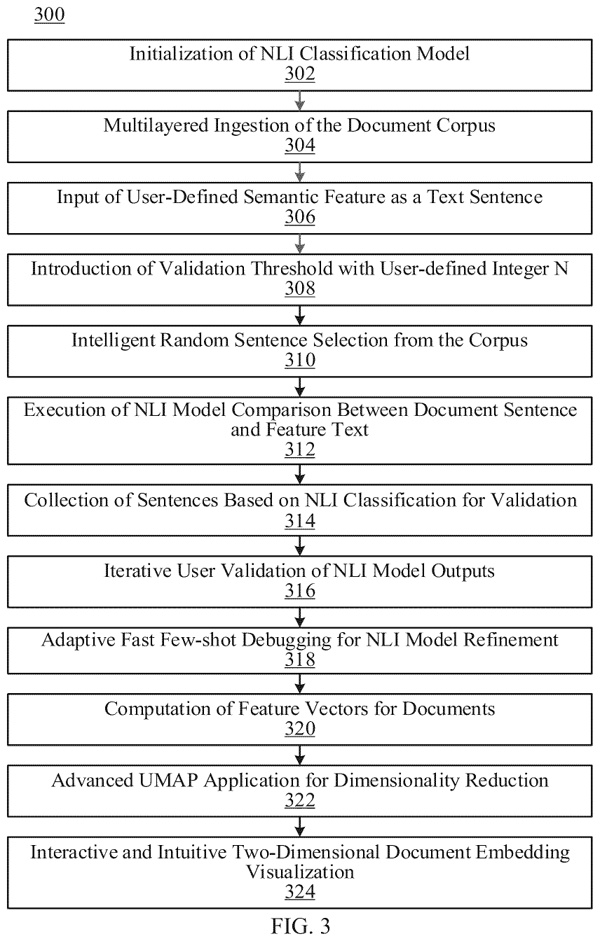

Referring now to FIG. 3, a diagram showing a method 300 for semantic analysis and iterative refinement of document corpuses through user engagement and machine learning techniques, is illustratively depicted in accordance with embodiments of the present invention.

In various embodiments, in block 302, a pre-trained NLI classification model can be initialized. This initialization is not a mere loading of the model but can include calibrating the model with the specific parameters of the application environment. It ensures that the model's knowledge base and inferential capabilities are in tune with the semantic granularity and the linguistic subtleties the system expects to encounter in the input documents. In block 304, a document corpus is ingested into the system. Here, the ingestion is not a simple data transfer but a multilayered process that can carefully parse and preliminarily analyze the documents to prepare them for further deep semantic processing. It can include an intelligent assessment of the data structure, extraction of preliminary semantic indicators, and organization of the data in a manner conducive to efficient and effective NLI model processing.

In block 306, the user can input a semantic feature, which is a text sentence defining a particular semantic concept or theme they wish to explore across the document corpus. This input is processed through a sophisticated user interface that interprets and validates the natural language input, ensuring it aligns with the system's operational parameters and is readily translatable into a computational semantic query. In block 308, the user provides an integer N that serves as a validation threshold for the system. The entry of this integer is a nuanced process that involves the system providing feedback and recommendations on the optimal number based on the size and nature of the corpus, the complexity of the semantic features, and the desired confidence level for the classification process. In block 310, a random sentence from the corpus can be selected, but this selection is not left to chance. Instead, it employs intelligent algorithms that consider the distribution of content, variation of themes, and representativeness of the sample to ensure that the random selection is nonetheless a statistically valid representation of the entire corpus, in accordance with aspects of the present invention.

In block 312, the NLI model can engage in a comparison between the randomly selected document sentence and the user-defined feature text. This comparison is an intricate process where not just the content but also the context, the subtleties of linguistic expression, and potential semantic implications can be analyzed to derive a classification that reflects the logical implication relationship between the sentence and the feature. In block 314, sentences can be collected based on the output of the NLI model, and this collection is sophisticated, prioritizing sentences where the model shows high confidence of an implication or indicates significant uncertainty. This approach ensures a focused collection of sentences that will be most beneficial for the validation and model refinement process. In block 316, collected sentences are presented to the user for validation in an iterative process that invites user engagement and applies their expertise to confirm or refute the model's classifications. This validation interface is designed to be user-friendly, providing context and explanations for the model's classifications and allowing the user to easily provide their assessments.

In block 318, Fast Few-shot Debugging can be utilized to refine the NLI model with the user's validated sentences. This debugging process is adaptive, capable of handling a diverse range of feedback and integrating it into the model's learning in a way that improves the model's predictive accuracy and semantic understanding. In an illustrative example, assume we are given a model p_{θ}(x,y) trained on training set X. Also assume we are given a debugging training set X′, an original test set Xₜₑₛₜ and a debugging test set X′ₜₑₛₜ. These four sets are pairwise disjoint. We consider the cross-entropy loss:

$$( x , y ; θ ) = - {p}_{θ} ( x , y ) log {p}_{θ} ( x , y ) \qquad ( 1 )$$

This debugging method initializes θ₀=θ and then performs intensive fine-tuning on the debugging set X′, by performing Adam iterations θₜ₊₁=Adam ( [symbol] , X′, θₜ) where Adam ( [symbol] , S, θ) represents the parameter update achieved by training θ with respect to the loss [symbol] over a complete epoch on S. Intensive fine-tuning stops at the minimal step t=tₓ such that argmax_{y} P_{θ}_{ₜ}(xᵢ, y)=yᵢ for all (xᵢ, yᵢ)∈X′. We write θₓ′=θₜ_{_{X′}}.

Next we can collect random samples W⊂X that are misclassified by θ_{x′} but not by θ. In our experiments we select |W|=2|X′| such examples. Collecting W is a fast process involving iterating through a random shuffle of X and stopping when the required number of examples is retrieved. The expected iteration time depends only on the error rates and correlation of the errors of the models and not on the size of the original training set |X|. Next we can restart from the original parameters θ and intensively fine-tune using the set X′∪W. We take θ′₀=θ and iterate Adam

$${θ}_{t + 1}^{′} = Adam ( , {X}^{′} ⋃ W , {θ}_{t}^{′} ) \qquad ( 2 )$$

until we reach t′ where argmax_{y} P_{θ′}_{_{t′}}(xᵢ, y)=yᵢ for all (xᵢ, yᵢ)∈X′∪W. The resulting θ′=θ′_{t′} is the debugged model, in accordance with aspects of the present invention.

In block 320, the system computes feature vectors for each document with enhanced precision. This computation is not simply binary but incorporates the subtleties and complexities of the user-validated implications, creating feature vectors that accurately represent the presence and nuances of the semantic features within the documents. In block 322, UMAP can be applied to the feature vectors for dimensionality reduction. This application of UMAP goes beyond standard procedures by considering the unique characteristics of the semantic data, ensuring that the resulting two-dimensional embeddings preserve the meaningful semantic relationships identified in the high-dimensional space. In block 324, the reduced embeddings are visualized in an interactive and intuitive two-dimensional space. This visualization is the culmination of the system's processing, presenting the user with an easily interpretable graphical representation of the document corpus, where semantic similarities and disparities are made clear through spatial proximity, in accordance with aspects of the present invention.

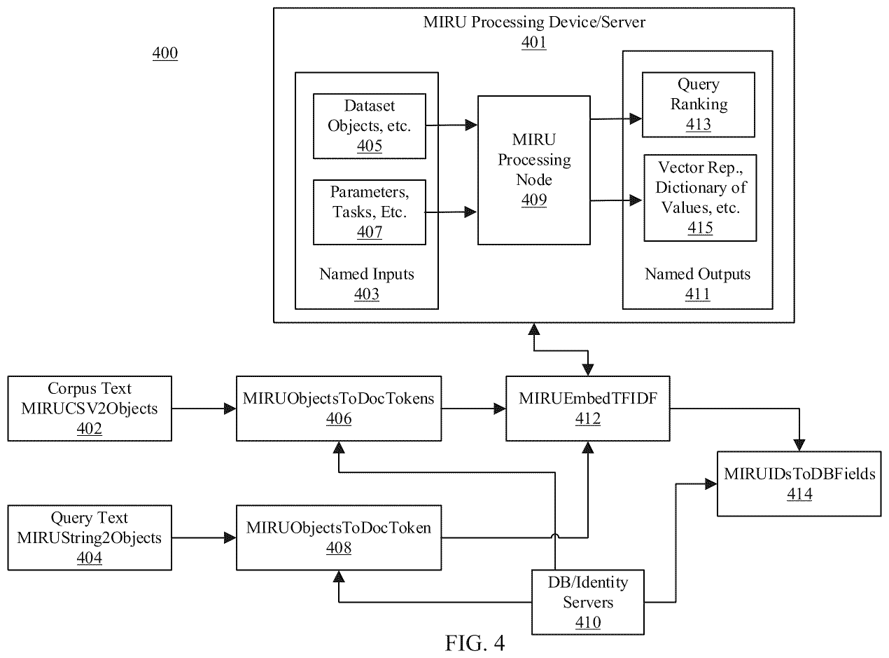

Referring now to FIG. 4, a diagram showing a system and method 400 for interactive, dynamic document retrieval, analysis, and processing, including semantic feature extraction, document tokenization, and query ranking using integrated diverse document analysis tools within a centralized processing environment, is illustratively depicted in accordance with embodiments of the present invention.

In various embodiments, in block 401, a specialized processing system (e.g., MIRU processing device/node/server) can serve as a central command center for managing and coordinating the entire workflow of the system architecture (e.g., MIRU architecture). It oversees the orchestration of data flow, directing inputs to appropriate processing nodes, initiating tasks based on user commands or system logic, and ensuring the smooth operation of the microservices within the network. It also acts as a gateway for data processing, receiving corpus and query texts, and outputting processed representations and query results. This server is equipped with sophisticated software that allows it to handle complex data structures, maintain state across sessions, and respond dynamically to the varied needs of the users.

In block 402, the corpus text enters the system and undergoes a transformation through the MIRUCSV2Objects module. This operation is critical for converting bulk, unstructured textual information into discrete, structured objects that can be systematically analyzed. The transformation encompasses several layers of processing, where the raw corpus is cleaned, tokenized, and organized into a standardized object-oriented format. Each object represents a distinct element of the dataset, encoded with metadata and attributes that facilitate further analysis by subsequent processes in the MIRU architecture.

In block 403, named inputs, such as dataset objects, processing parameters, and tasks, are ingested into the system with an advanced categorization process. This sophisticated step involves parsing the inputs to identify the nature and requirements of each dataset object, extracting parameters that define the scope and limitations of tasks, and ensuring that each input is meticulously categorized for optimal processing efficacy. This block employs intelligent algorithms to decipher user instructions and translate them into actionable tasks within the MIRU environment. In block 404, the system takes user-provided query text and converts it into structured objects through the MIRUString2Objects function. This detailed transformation process includes the analysis of the query text, identification of key terms, and the creation of objects that encapsulate the user's query intent. These objects are then indexed and prepared for interaction with the system's data processing nodes, allowing the query to be understood and matched against the processed corpus data.

In block 405, the dataset objects, parameters, and tasks are introduced to the MIRU Processing Node. This step is akin to setting the stage for a performance, where all actors (data and parameters) are placed in their starting positions, ready to act upon the director's (user's or system's) command. The block ensures that all components are synchronized and prepared for the intricate data processing that follows. In block 406, the structured objects derived from the corpus text are meticulously tokenized through the MIRUObjectsToDocTokens function. This tokenization process delves deep into the granularity of the text, breaking it down into its most basic elements-tokens, which represent words, phrases, or other significant textual units. The function also handles the complexities of different languages, nuances of syntax, and the idiosyncrasies of linguistic expressions, transforming the text into a tokenized format that is universally interpretable by the system's analytical tools.

In block 407, the system delineates processing parameters and defines tasks in a comprehensive manner. This block details the sophisticated logic that underpins the system's decision-making process, dictating how data will be treated, the conditions under which tasks will be executed, and the criteria that will be used to measure the success of these tasks. The parameters and task definitions are critical in sculpting the raw data into meaningful outputs, ensuring that the system's processes are fine-tuned to meet the nuanced demands of the user. In block 408, a similar refined conversion process occurs as in block 406, turning structured query objects into document tokens through the MIRUObjectsToDocToken function. This critical operation ensures that the query is dissected into analyzable tokens, matching the format and structure of the corpus data, thereby enabling an apples-to-apples comparison and analysis within the system.

In block 409, the MIRU Processing Node stands as the central analytical powerhouse of the system, equipped to handle the detailed processing of tokenized data. Here, sophisticated algorithms interpret, compare, and derive meaning from the corpus and query tokens, executing the user-defined tasks with precision and agility. This node also manages the interactions between various sub-processes and ensures the data is primed for the next stages of analysis or visualization. In block 410, the databases or identity servers are detailed in their role of interfacing with the MIRU Processing Node. These components are responsible for the secure storage, efficient management, and swift retrieval of tokens, document identifiers, and their interconnected relationships. The servers are built to support high-throughput operations, maintain data integrity across multiple accesses, and provide a reliable foundation for the system's data storage needs.

In block 411, named outputs, an final output of the system's processing efforts, are compiled and detailed. Outputs such as query rankings and vector representations are the distilled essence of the system's processing capabilities, transformed into formats that users can easily interpret and utilize. This block details the algorithms that rank query results and the techniques used to synthesize high-dimensional data into vector representations, making the complexities of data analysis accessible and actionable for the end-user. In block 412, the tokenized documents are subject to an embedding process using the MIRUEmbedTFIDF function, which is elaborated upon. This process leverages advanced statistical and machine learning techniques to calculate term frequency and inverse document frequency scores, thereby generating embeddings that provide insightful representations of document significance and term relevancy within the dataset.

In block 413, the system's outputs are meticulously organized based on a set of predetermined relevance metrics through the Query Ranking function. This process is elaborated to highlight the complex algorithms and sorting techniques employed to ensure that query results are ordered in a manner that prioritizes the most relevant and significant information, facilitating efficient user review and decision-making. In block 414, document identifiers are mapped to database fields through the MIRUIDsToDBFields function with detailed exposition. This function acts as a translator between the tokenized representations and their source documents, enabling the system to trace and retrieve data accurately, ensuring that every piece of information can be pinpointed and contextualized within its original document. In block 415, vector representations and dictionaries of values are synthesized with amplified detail. This synthesis encompasses the conversion of raw data into vector space models, employing complex mathematical transformations and machine learning algorithms to enable multifaceted analyses, including clustering and similarity assessments, in accordance with aspects of the present invention.

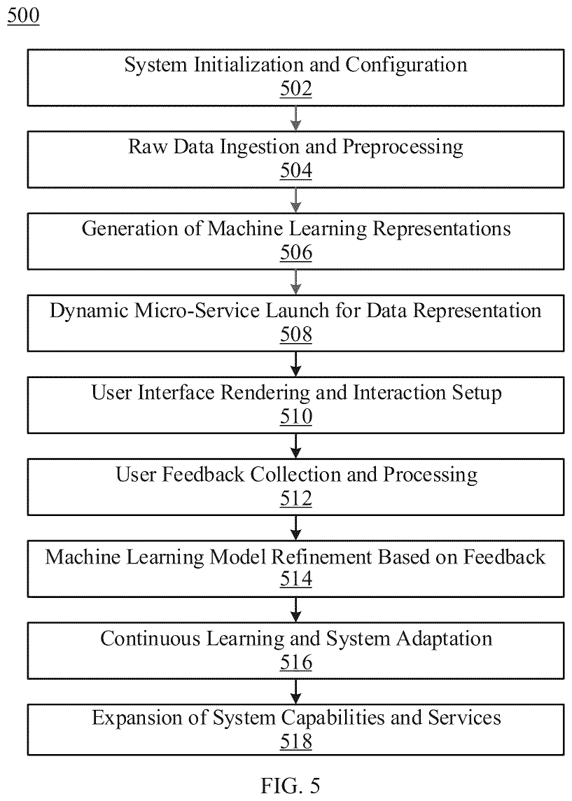

Referring now to FIG. 5, a diagram showing a method 500 for interactive, dynamic document retrieval, analysis, and processing using a multi-stage approach for system setup, data handling, user-driven machine learning refinement, and ongoing system optimization, is illustratively depicted in accordance with embodiments of the present invention.

In various embodiments, in block 502, the process begins with the initialization of a specialized processing node (e.g., MIRU processing node), setting up the foundational structure for managing micro-services within a browser-based application. This involves configuring the node to support dynamic data processing pipelines capable of handling various data types (e.g., textual, imagery, etc.) and formats. The system architecture is laid out, including the establishment of communication protocols with a message broker to facilitate inter-service messaging and data exchange. In block 504, raw data ingestion commences, where data is sourced from diverse origins such as databases, live feeds, or user uploads. The preprocessing stage involves cleaning (e.g., removing noise or irrelevant sections), normalization (standardizing formats), and tokenization for textual data or analogous steps for imagery (e.g., resizing, color normalization). This stage prepares the raw data for further machine learning processing, ensuring consistency and quality in the inputs.

In block 506, the processed data undergoes transformation into machine learning representations. Depending on the data type, this could involve creating embeddings from text using algorithms like Word2Vec or Doc2Vec, or generating feature vectors from images using convolutional neural networks. This stage encapsulates the core analytical processing, turning raw data into structured, analyzable forms that capture the inherent patterns and characteristics of the input.

In block 508, for each set of processed data or specific task, a dedicated micro-service is dynamically launched. These micro-services are designed to hold the generated machine learning representations in memory, offering an API endpoint for querying and interaction. The launch process includes assigning resources, defining the operational parameters (e.g., the algorithms to use, the data scope), and establishing a communication link with the main MIRU processing node and other related services.

In block 510, an interactive user interface is rendered in the browser, designed to display the machine learning representations visually, such as through scatter plots or heatmaps for document embeddings. This interface is equipped with tools for user interaction, including zooming, selection for detailed view, and mechanisms for providing direct feedback on the data or its representation (e.g., tagging, repositioning points). In block 512, user feedback gathered through the interface is processed. This feedback might range from corrections to the data labels, adjustments in the visual representations (e.g., moving a document closer to another to reflect perceived similarity), or textual annotations. This feedback is systematically categorized and prepared for integration into the system, setting the stage for real-time adaptation and learning.

In block 514, the collected user feedback is used to refine the underlying machine learning models. This involves adjusting model parameters, retraining models with new or corrected data, and possibly initiating Fast Few-shot Debugging processes for quick adaptation. This block is critical for evolving the system's accuracy and relevance to user needs, ensuring that the machine learning representations are continually improved.

In block 516, the system enters a phase of continuous learning and adaptation, where it iteratively refines its processes based on new data, user feedback, and changing requirements. This includes updating the data processing pipelines, adding or modifying micro-services, and enhancing user interface functionalities. The system monitors its performance, gathering metrics for optimization and ensuring that the architecture remains responsive and scalable. In block 518, leveraging insights from ongoing operation and user interactions, the system expands its capabilities and services. This might involve introducing new types of machine learning analyses, supporting additional data formats, or integrating external data sources and services. This block emphasizes the system's growth and evolution, ensuring it remains cutting-edge and highly useful to users, in accordance with aspects of the present invention.

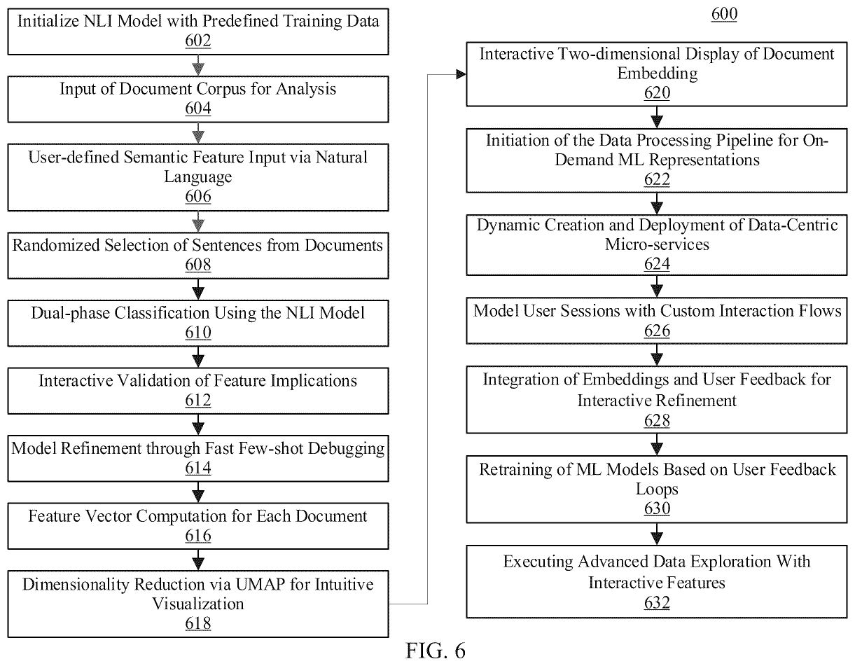

Referring now to FIG. 6, a diagram showing a method 600 for dynamic document analysis and visualization, integrating user-driven semantic feature input and interactive machine learning refinement, is illustratively depicted in accordance with embodiments of the present invention.

In various embodiments, the method 600 can leverage natural language inference models and dimensionality reduction techniques to create visual embeddings of documents, enabling users to explore, annotate, and refine document collections in real-time based on semantic similarities and user feedback, thereby improving speed and accuracy for enhanced document discovery and analysis in various domains such as legal research, medical literature review, and academic studies. The present invention can quickly and efficiently process and visualize data based on user-defined semantic features and interactively generate machine learning representations in web applications, in accordance with aspects of the present invention. In block 602, a Natural Language Inference (NLI) classification model can be initialized using a predefined set of training data. The model should be capable of binary classification tasks to ascertain if one text segment logically implies another. This step involves setting up the computational framework, loading the NLI algorithm, and pre-training on a diverse dataset to ensure broad initial understanding of language patterns and logical inferences.

In block 604, a comprehensive set of documents, such as court opinions or technical papers, can be introduced into the system. This can include preprocessing steps like text normalization, tokenization, and language detection to prepare the documents for detailed analysis, and to ensure that the corpus represents the variety and complexity of the subject matter relevant to the user's interests or query parameters. In block 606, an interface for users to input semantic features in natural language can be implemented, describing high-level concepts or criteria of interest. This interface can guide users on how to frame their features effectively and can include examples or templates for enhancing accuracy and usability for end users. The system captures these inputs, processes them for clarity and specificity, and prepares them for comparison against the document corpus.

In block 608, sentences can be randomly selected from the document corpus to ensure unbiased sampling. This can include generating a random or pseudo-random sequence to pick sentences across the entire corpus, ensuring a broad representation of content for preliminary feature comparison. In block 610, a dual phase classification process can be implemented using the NLI model. This can include a positive implication phase, in which pairs of user-defined feature texts and document sentences can be analyzed and classified to identify positive implications. This can also include a high-uncertainty negative implication phase, which can identify negative implications with comparatively high uncertainty for further examination. This dual-phase approach ensures both clear matches and potential mismatches can be quickly and efficiently scrutinized for accuracy by the system in real-time, in accordance with aspects of the present invention.

In block 612, interactive validation of feature implications with user engagement can be executed, and can include presenting the classified sentences to users for confirmation. This step can involve a graphical user interface displaying sentences, their implied features, and options for users to confirm or correct the classification. This step can further ensure that user feedback is efficiently captured and accurately integrated into the system for model refinement. In block 614, model refinement can be performed using, for example, fast few-shot debugging techniques to refine the NLI model based on user feedback. This can include adjusting the model's parameters or retraining it on the newly validated sentence-feature pairs to improve classification accuracy. The system can document changes for transparency and allow iterative debugging to enhance reliability and accuracy.

In block 616, feature vectors for each document can be calculated, where each vector element represents the presence (1) or absence (0) of a document sentence logically implying a user-defined feature. This computation can include parsing each document in its entirety, applying the refined NLI model, and aggregating the results into a structured vector format for further analysis, in accordance with aspects of the present invention. In block 618, a Uniform Manifold Approximation and Projection (UMAP) algorithm can be applied to the computed feature vectors to reduce dimensionality to a two-dimensional space conducive to intuitive visualization. This step optimizes the embedding for visual distinctiveness and user interpretability, preserving the relative semantic distances between documents based on the user-defined features.

In block 620, the resulting two-dimensional embedding of documents can be presented to one or more users through an interactive display interface. This user-customizable interface can enable users to explore the document space, select individual points to reveal document details, and understand the semantic proximity of documents based on their input features. The interface can also support zooming, panning, filtering, etc. to aid in user exploration and discovery, in accordance with aspects of the present invention. In block 622, a robust data processing pipeline capable of generating machine learning (ML) representations from raw data inputs (e.g., text, images) on demand, can be initiated and utilized. This pipeline can include preprocessing steps (e.g., normalization and tokenization for text), feature extraction, and initial ML model application to create embeddings or other statistical representations. The system can dynamically adapt to varying data types and user requests in real-time, ensuring flexible and responsive representation generation, in accordance with aspects of the present invention.

In block 624, data-centric micro-services for each unique dataset or representation requested by users can be dynamically created in real-time during use. These micro-services can be responsible for maintaining in-memory representations of data and providing a queryable API. The creation process can include specifying the dataset, determining the appropriate statistical method or ML model (e.g., TF-IDF, embeddings), and deploying the service to listen for and respond to queries, in accordance with aspects of the present invention. In block 626, user sessions can be modelled through the deployment of user-centric threads, each tailored to the interaction patterns and data exploration needs of the individual user. These threads can track user actions, preferences, and feedback, enabling personalized interaction flows and responsive UI elements within the browser-based application. This setup facilitates a coherent user experience that seamlessly integrates with the underlying data-centric services.

In block 628, ML representations, such as document embeddings, can be visualized in a user-interactive manner, allowing for direct manipulation and feedback. Users can adjust the positioning of points within embeddings to reflect their perception of document similarity or relevance, thereby providing explicit feedback on the ML output. The system can capture these adjustments and prepares them for integration into the representation refinement process. In block 630, mechanisms for retraining ML models can be implemented based on user feedback, adjusting the models to correct outputs or refine embeddings in line with user-provided labels or positioning adjustments. This step involves collecting feedback, updating the model training dataset with new examples or adjustments, and applying fine-tuning or full retraining procedures to incorporate the feedback effectively. In block 632, advanced data exploration features can be provided and utilized within the browser application, enabling users to interact with the data representations in sophisticated ways. This can include interfaces for querying specific document attributes, filtering based on metadata, applying different visualization techniques to uncover patterns, etc. to offer users a comprehensive toolset for deep dives into the data, powered by the responsive, on-demand data representations, in accordance with aspects of the present invention.

In various embodiments, the present invention can make interactive applications in a web browser that generate and use machine learning representations. Examples of machine learning representations could include embeddings (vector representations of documents, images or sentences), or another statistical representation of a set of documents (eg. A TF-IDF matrix, which calculates word occurrence statistics over a set of documents). Machine learning representations can be produced at the end of a series of transformations, and when processing text this can be referred to as a NLP (Natural Language Processing) pipeline. The present invention can create representations on the fly (e.g., building ML representations of data from raw data, such as text or raw images, display visualize the representations to the user (e.g., rendering a 2-dimensional scatter plot of the document space of a corpus using the embedded representation of the documents), and an interface for users to interact with those representations.

In various embodiments, interacting with the representations can include receiving user feedback on the veracity of the ML produced output (e.g., by providing labels for examples produced by a machine learning model, the model can be retrained to correct the output based on the feedback), and/or receiving user feedback on the embeddings of examples. This can mean literally dragging points on the user interface (e.g., in a scatter plot) to declare the users which that certain documents should appear near other documents, or that the user wishes to express a certain ordering of documents over one axis of the output. For example, in an embedding of cats or dogs, the user can drag a few examples of cats to x<0 and a few examples of dogs to x>0. Then the user can request another optimization of the embedding for the visualization that takes this feedback as part of the objective function while re-embedding the space to reflect the user feedback. The system can further propose keywords or documents to refine a document search based on previous user actions, in accordance with aspects of the present invention.

Traditionally, web applications are built using a Web-Server (eg. Apache) and Client architecture. The web server serves html and javascript code to the client (the web browser). The web server also tracks the user session and can run server-side scripts (for example PHP scripts) to support the application. Some application frameworks offer “Python only” servers that create and serve javascript and html from python scripts. Such frameworks include Django, Plotly, and Dash. More recently, web applications might be served from a scripting engine on the server side such as nodejs (javascript) or Flask (Python). In this case, the web server also manages user sessions and executes code on behalf of the user inside the server. Such code may make request of external resources such as Databases or other APIs from other servers or services.

In various embodiments, the present invention can target end user applications in the browser, with applications being served by a micro-service architecture consisting of many micro-services connected via a message broker. The micro-services combine to implement pipelines that generate ML representations and/or finetune models in response to user actions. MIRU differs from traditional servers because our network of microservices has a common implementation and API. Microservices are implemented as independently running threads that are connected together via a common message broker. The threads can be in the same process, on the same machine, or on different machines.

While it is common in a server client-architecture to launch a thread to handle executing server-side script for a particular user session, MIRU can do that and more: The network of micro-services that MIRU provides form a loosely associated pool of functionality of many types. Threads of many types can be launched for many reasons through the common API:
1. User centric threads: A backend session-A python thread corresponding to a user session. The user session may be in javascript in a web browser. These threads might implement a particular kind of user application. A javascript “frontend” can be paired with a python “backend”, with the pair forming a user application.
2. Data centric threads: A python thread corresponding to some model of the source data. For example, a dataset can be processed into an intermediate form in memory (for example a TFIDF matrix of a dataset representing word frequencies). That form can then be_queried_by other microservices. That is, a thread is launched and populated with the source data, a representation is built that adds value to the data, an API is provided for other micro-services to query that representation, and query requests are handled by the thread and responses sent out using the common broker.
3. A thread can be launched to model a particular user interaction inside of an application (as in 1). For example, as part of an application we can build a model of the user by a sequence of human computer interactions in a micro-service thread. In experiments, the user has been offered multiple images and feedback was requested in order to discover the users preference over a set of images. In experiments, we have used a published method called LinearUCB (Linear Upper bound Contextual Bandits) to create a linear model of the users' preference and use it to recommend new images to the user. Images can be recommended to both provide the user with more of what he/she wants, and also to gain the maximum possible understanding of the user's preference from new feedback.
4. Worker centric thread: Microservices are attached to the message broker by use of queues, and multiple worker threads can be initialized with the same data. Requests sent to the thread are queued and delivered to idle threads.

In various embodiments, a broker service in MIRU can be responsible for delivering messages from service to service. In one instantiation, an exemplary message broker is RabbitMQ. Threads can be launched and managed by “manager threads” which are connected to the message broker. The manager threads can create and destroy threads, and can forward messages from the broker to the queues of the launched threads. These design decisions lead to a very flexible framework with high growth and scalability potential, as new module types are developed and added to the system. The present invention includes several elements that diverge from a conventional data analysis tool and server-client architecture, including, for example, on demand representations using a pipeline engine, data centric threads that form in memory representations of datasets and provide a query API, and user centric threads that model user session objects and provide an interaction API. In some embodiments, there is not a central server to serve one or more datasets, but many micro-servers that are dataset specific. They can be created as part of pipeline execution on requests from the user and they provide an API to query them, in accordance with aspects of the present invention.

Managing ML and NLP pipelines and workflows is a common problem and many pipeline libraries exist, from user defined scripting language scripts to online DAG workflow processing engines such as PyFlyte and AirFlow. Generally, each step of a pipeline takes one or more inputs, applies a function and produces output. The inputs and outputs might be stored in memory, on the file system or in some database. For illustrative purposes, we discuss utilization of one such pipeline engine (Luigi) to implement NLP and image processing pipelines, noting that any sort of pipeline engine can be utilized in accordance with aspects of the present invention. The use of Luigi in the present invention differs from normal in that typically the intermediate results of those computations are discarded. We utilize some in memory intermediate representations, and with appropriate exposing APIs they can support novel applications.

For example, in our example case (e.g., 2: Data Centric Threads), in some instances we would like to retrain the intermediate representation (eg. A TD-IDF thread with a matrix modelling the data, or a linear model representing user feedback in a session) in a micro-service and provide an interface (API) so that other micro-services can query it. In the case of a TF-IDF server for instance, the TF-IDF matrix can be retained in memory in an active thread that can respond to queries that arrive on the queue from the message broker.

Another example of a data-centric online service is an embedding micro-service that can take high dimensional vector representations of sets images or documents as input and provide an API that can be queried by applications. This API can provide 2 dimensional embeddings of the whole dataset on demand, or respond to queries for 2D embeddings of subsets of the database that have been selected by the user. Furthermore, this service can response to user feedback by implementing user defined constraints on the documents in an embedding (such as the positions of the documents in the final embedding).

In various embodiments, many data-centric microservices can be created in real-time during use (e.g., one for each set of documents and initializing parameters) and each can retain the data constructs in memory that can be utilized to rapidly provide response to queries from it's API. Note that not all outputs of pipeline steps are micro-services, and a query result can be stored in a DB or as a simple file, and then returned to the user applications. If a query has been made before against the same dataset with the same parameters, then the pipeline engine can automatically return the previous result from the store, in accordance with aspects of the present invention. Pipelines can be expressed by their inputs (requirements) and their targets (outputs).

We can implement a special “Target” in the pipeline engine that represents an “Online micro service Thread” for a microservice described by the given initialization parameters. For example, the initialization parameters could be: the dataset, the statistical method, the hyperparameters for the method, etc., in accordance with aspects of the present invention. If when required by a pipeline, the micro-service does not exist (e.g., some statistics about a dataset), then the micro-service can be launched by MIRU as a new thread and it begins listening for API requests. On receipt of data, it can process that data and then can respond to queries on the in-memory representations produced (eg. respond to a query text request).

In various embodiments, when a user makes a request from a service for a query to be processed, the pipeline engine can first check to see the micro-service to be queried exists, and if it doesn't it can execute the pipeline require to prepare the data to initialize the service (e.g., from raw text files if necessary), and launch the micro-service and populate it with the processed data. The microservice can then service the request from the user. By launching micro-services as intermediate steps in a pipeline, a very simple high level API can be provided to the application programmer for the requested user actions (e.g., perform a text query against a TFIDF server for dataset A) and this can both start the execution of the dataset→TFIDF pipeline, launch and populate the microservice, execute the query and serve the result. In this way, initializing a server with datasets and preprocessed results is not required, but rather the present invention can respond to the user's requests, and generate representations on demand, some of which can result in online, in-memory, threaded microservices that can respond very quickly to more requests from the same user, or other clients, in accordance with aspects of the present invention.

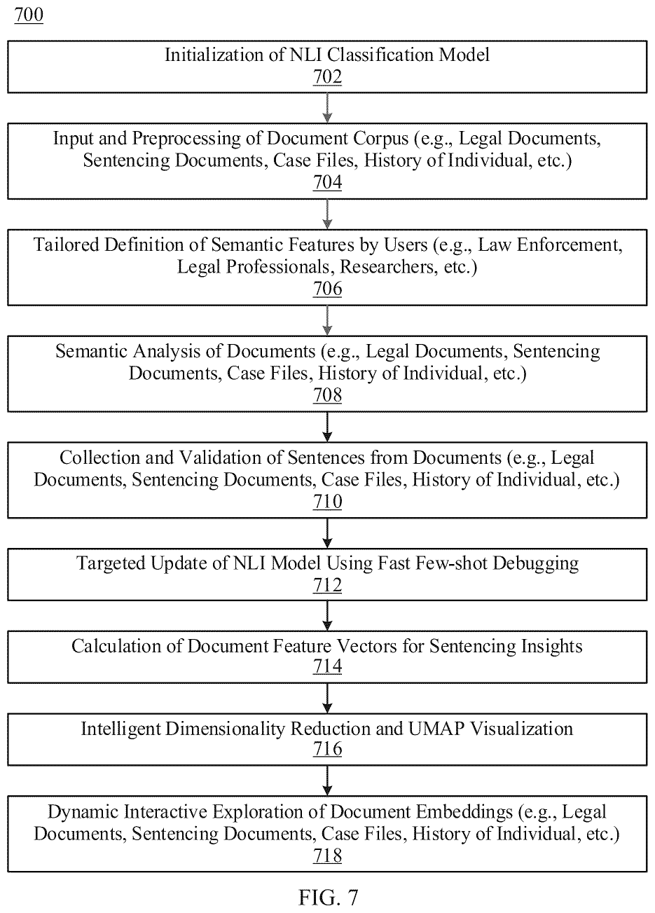

Referring now to FIG. 7, a diagram showing a method 700 for automated, machine learning-implemented semantic feature-based analysis and interactive visualization of legal documents for automatically generating recommendations (e.g., sentencing recommendations) in real-time, is illustratively depicted in accordance with embodiments of the present invention.

In various embodiments, in block 702, the MIRU system commences by meticulously initializing an NLI classification model, a sophisticated artificial intelligence tool pre-trained to comprehend and classify linguistic implications in legal contexts. The initialization process harnesses a rich dataset of legal documents—like court opinions, police reports, and affidavits—to ensure the model's adeptness in capturing nuanced semantic relationships essential for identifying similarities in criminal cases. In block 704, a curated compilation of legal texts, which may encompass detailed police reports, witness interviews, and court transcripts, is fed into the system. The preprocessing stage is a critical juncture where the text undergoes normalization, tokenization, and other NLP tasks to prepare the corpus for deep semantic interrogation by the NLI model. This stage ensures that the corpus reflects a standardized linguistic framework conducive to precise semantic feature extraction.

In block 706, legal professionals or other system users can define specific semantic features that are identified as important to the sentencing process, such as affiliations with criminal organizations, roles in criminal activities, economic status, and capacity for remorse. These high-level features can be input into the system as natural language sentences, effectively bridging human expertise with machine intelligence for the identification of critical factors in sentencing decisions. In block 708, the NLI model undertakes a rigorous semantic analysis of the legal documents against the defined features. Each sentence in the corpus is evaluated for its logical implication of the user-defined features. This meticulous analysis employs the model's binary classification to discern semantically relevant text, laying the groundwork for creating a semantic profile of each document within the corpus.

In block 710, sentences from the legal documents are selectively gathered based on their implications as determined by the NLI model. High-confidence classifications and those near the confidence threshold are earmarked for user validation. In this stage, legal professionals can interact with the system and play an role by reviewing and affirming the sentences, thereby corroborating the model's interpretation and enhancing the semantic implication profiles. In block 712, the MIRU system refines the NLI model through a process known as Fast Few-shot Debugging, integrating user-validated sentences to fine-tune the model's accuracy. This update is not a mere recalibration but a targeted evolution of the model to more precisely reflect the subtleties of legal semantics and user expectations, enhancing the model's performance for the specific application of criminal case analysis, in accordance with aspects of the present invention.

In block 714, feature vectors can be calculated for each document, encoding the presence or absence of user-defined features as binary values. These vectors are not simplistic representations but encapsulate the intricate semantic nuances vital for sentencing decisions, providing a quantifiable basis for comparing and contrasting cases. In block 716, dimensionality reduction via UMAP transforms the feature vectors into an intelligible two-dimensional space for visualization. This step is where the complexity of legal semantics is distilled into a visual format, enabling users to discern patterns and relationships between cases based on the semantic similarity of the documents, directly supporting the determination of sentencing lengths and related legal analyses.

In block 718, the two-dimensional embeddings are presented within an interactive exploration interface. User (e.g., judges, lawyers, legal researchers, students, etc.) can engage with the visualization, dynamically manipulating document positions to reflect or explore various sentencing scenarios based on the defined semantic features. This interaction is not static but a real-time dialogue with the system that influences the semantic analysis, ensuring that the visualization aids in practical real-time sentencing decisions (and providing arguments with support for or against an ordered sentence by a judge), and legal scholarship. The present invention can apply NLI models for semantic feature-based analysis within the legal domain, particularly for criminal sentencing (in this illustrative embodiment), by enabling legal professionals to define, validate, and visualize semantic features in a way that directly influences real-world legal outcomes, in accordance with aspects of the present invention.

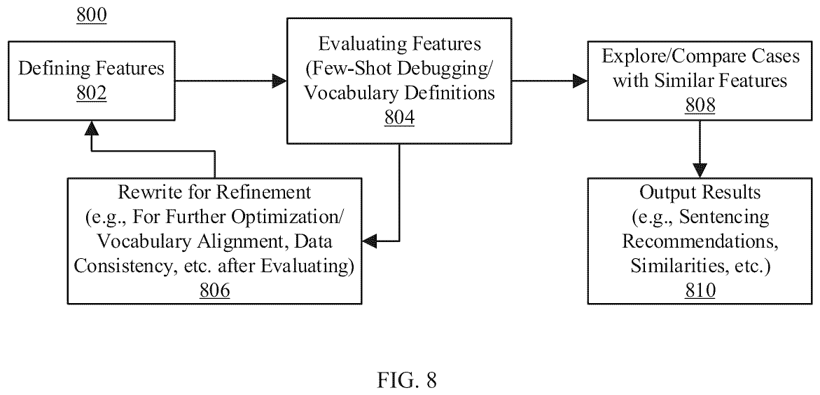

Referring now to FIG. 8, a diagram showing a method 800 for generating actionable insights and recommendations based on user-driven semantic feature definition, in-depth evaluation through few-shot debugging, and automated comparative analysis of documents based on refined semantic profiles, is illustratively depicted in accordance with embodiments of the present invention.

In various embodiments, in block 802, the method 800 can commence by users defining semantic features of interest. For example, in a legal context, this can include features relevant to criminal sentencing, such as ‘affiliation with an antisocial organization’ or ‘display of remorse by the defendant.’ These features are not arbitrary keywords but are formulated based on the high-level semantic concepts that users want to explore within the document corpus. The system facilitates this process through a user-friendly interface, where features can be entered as natural language statements.

In block 804, the user-defined features can be evaluated against the corpus. This evaluation uses a Natural Language Inference (NLI) classifier that has been fine-tuned to the context of the documents (e.g., legal texts, police reports, academic papers, news articles, interviews, etc.) through a few-shot debugging process. The debugging process is an iterative refinement that incorporates user feedback to improve the classifier's understanding of the semantic features, aligning the system's vocabulary with the user's intent. In block 806, following the initial evaluation, a rewrite phase can be commenced, and can be utilized for aligning the model's understanding with the newly refined semantic definitions post-debugging. It's a sophisticated recalibration that ensures consistency and accuracy in the system's representation of the documents. In practice, this can involve updating the model to recognize, for example, that ‘expressed remorse’ and ‘apologized for the crime’ are related concepts, or that ‘affiliation with a gang’ implies a connection to ‘antisocial organizations.’

In block 808, the MIRU system leverages the updated model to explore and compare cases based on the refined semantic features. In a legal context, this could mean identifying and grouping cases where defendants have shown remorse or have affiliations with certain organizations. This step can be utilized by end users such as legal analysts or sentencing judges who need to compare cases on a semantic level rather than just by keyword matches. The system presents the findings in a user-friendly format, often visually, allowing for easy comparison and exploration of similar cases. In various embodiments, the exploring and comparing cases with similar features can leverage a refined NLI model to provide deep insights into the document corpus as follows.

In block 808, the MIRU system utilizes the calibrated NLI classification model to embark on an advanced exploration and comparative analysis of cases within the document corpus. This sophisticated analysis is not a simple keyword search but an intricate semantic exploration that leverages the context and nuances of the user-defined features as understood by the refined NLI model. Firstly, semantic implication profiles for each document can be extracted based on the updated NLI model. It can interpret sentences within the documents, mapping them against the user-defined semantic features to gauge the strength of their implications. This process employs algorithms capable of understanding complex semantic relationships and can discern contextually relevant information from each document in relation to the defined features.

Next, a comprehensive comparison of these semantic profiles can be conducted, and can identify and group documents that exhibit similar semantic features, such as legal cases where defendants show comparable behavioral patterns or possess similar attributes of interest. This comparison can be based on the composite implication scores aggregated earlier in the process. A visual representation of the semantic landscape can be created using techniques such as, for example, UMAP for dimensionality reduction. The documents can be plotted in a semantic space where proximity indicates similarity based on the composite semantic implication profiles. This visualization is dynamic, allowing users to interact with the representation, identify clusters of similar cases, or isolate outliers. The exploration component is also enriched by machine learning algorithms that can surface patterns and trends within the semantic space. For example, the system can reveal that cases with certain semantic features frequently result in specific sentencing outcomes or are often associated with particular case types.

In various embodiments, the MIRU system offers tools for users to conduct what-if analyses. Legal professionals can manipulate the semantic space to explore hypothetical scenarios, such as the impact of different semantic features on case outcomes. The system can track these explorations and can provide predictive insights based on the user's interactions, further informing their decision-making process. In a real-world legal setting, this deep semantic exploration enables professionals to perform nuanced case law research, sentencing analysis, and legal precedent studies, all in real-time for use in time-sensitive situations (e.g., courtroom setting). It allows for the cross-referencing of current cases with past cases based on semantic similarity, providing a robust analytical tool to support or oppose judicial decisions or legal research. The present invention can not only analyze and visualize the semantic content of document corpuses but also empower users with an interactive, machine learning-enhanced toolkit for conducting sophisticated legal analyses in real-time, in accordance with aspects of the present invention.

In block 810, the MIRU system can output the results of the exploration. This can manifest as a visual representation where documents are plotted in a two-dimensional space based on their semantic similarity, or through a list where documents with similar features are grouped together. For legal professionals, this can include sentencing recommendations, or highlighting cases with strong similarities to help in making informed decisions and arguments. The output is designed to be interactively refined, allowing users to manipulate the visualization based on their evolving analysis. The method 800 encapsulates a user-driven analysis flow where legal professionals can input and refine high-level semantic concepts, validate the system's understanding through few-shot debugging, and then use the refined model to explore and compare cases with similar features. This aids in tasks like determining sentencing lengths by finding cases that share semantic characteristics with the current subject, thus supporting a more informed and equitable legal decision-making process.

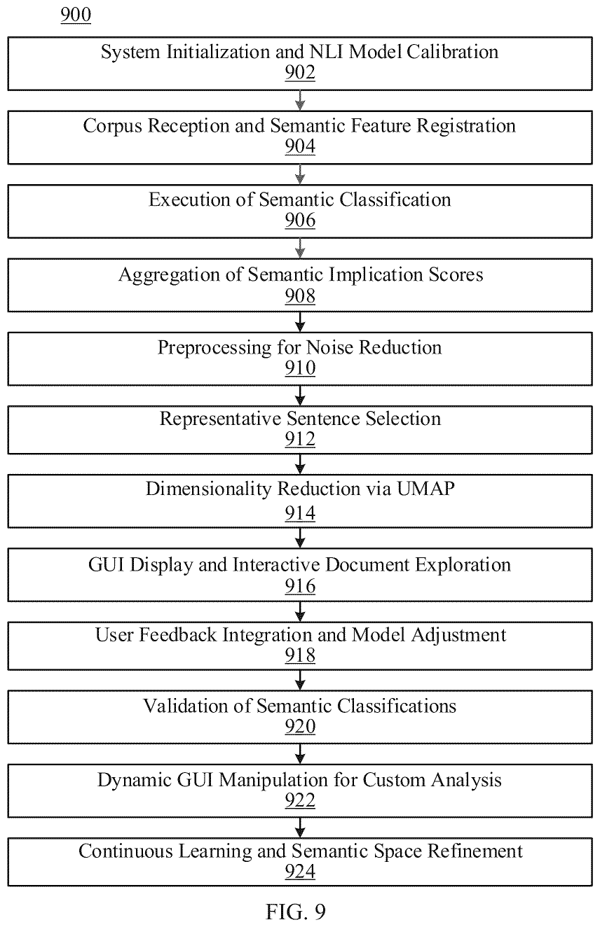

Referring now to FIG. 9, a diagram showing a method 900 for dynamically initializing, analyzing, and visualizing document corpuses in real-time through user-guided semantic classification and dynamic feedback integration for optimized interactive document analysis, processing, and exploration, is illustratively depicted in accordance with embodiments of the present invention.

In various embodiments, in block 902, initialization can be executed by calibrating the NLI classification model. This model, pre-trained on a linguistically diverse dataset, can be fine-tuned to comprehend a wide range of natural language constructs. The system ensures the model is prepared to assess the implication strength accurately, setting the foundation for subsequent semantic feature analysis. In block 904, a computing device can receive a corpus of textual documents alongside a plurality of semantic features described in natural language by the user. This step can include both the ingestion of textual data and the registration of semantic parameters, which can serve as benchmarks for the analysis.

In block 906, a rigorous classification process unfolds for each semantic feature. Here, the NLI model scrutinizes the corpus, sentence by sentence, executing a classification that determines the implication strength. It includes a sophisticated confidence scoring mechanism, quantifying the degree of semantic relevance for each sentence in relation to the user-defined features. In block 908, implication scores from the NLI classification can be aggregated across all semantic features for each document, forming a composite semantic implication profile. This profile is a holistic representation of the document's semantic structure, providing a baseline for visual representation. In block 910, preprocessing steps can be enacted to cleanse the corpus for noise reduction. The system can remove non-textual elements, normalize textual formats, and tokenize sentences, thereby purifying the text for a more accurate NLI assessment, in accordance with aspects of the present invention.

In some embodiments, in block 912, the system can generate a subset of sentences for each document to ensure representative coverage of the document content is selected for detailed NLI model analysis. In block 914, UMAP can be applied to the composite semantic implication profiles, converting the multi-dimensional data into a two-dimensional semantic space representation. This application is meticulously tuned to preserve the integrity and relational significance of the semantic features. In block 916, the two-dimensional semantic space be displayed via a GUI. This interface presents individual documents as selectable nodes, enabling users to intuitively explore the relationships between documents. The GUI's design emphasizes usability, encouraging user interaction for insight discovery. In block 918, iterative user feedback can be incorporated. This feedback, including indications of correct and incorrect semantic implications, prompts dynamic adjustments to the semantic space representation. The NLI model harnesses this feedback, using a fast few-shot learning process for real-time updates and refinements.

In block 920, selected sentences with high confidence scores and those near the confidence threshold can be presented back to the user for validation. Users confirm or correct the implications, providing updated data that the system uses to enhance the accuracy of the composite semantic implication profiles for future iterations. In block 922, the system's GUI extends its functionality, allowing users to manually reposition documents within the two-dimensional space. Such repositioning acts as additional feedback, empowering users to mold the semantic analysis landscape according to their insights, driving the NLI model towards a user-defined approach to document analysis. In block 924, the system enters a phase of continuous learning. Through the GUI, the system learns from user-driven document rearrangements, refining the classification process. The implication strength scoring is adjusted based on the rearrangement, fine-tuning the system's ability to match the semantic feature analysis with the user's conceptual understanding, in accordance with aspects of the present invention.

In various embodiments, the method 900 can utilize an MIRU architecture for semantic analysis of document corpuses based on user-defined features, encompassing, for example, initializing and tuning the NLI model, preprocessing documents, executing and validating semantic classification, and visualizing and interacting with the results, with an emphasis on user feedback and system adaptability, in accordance with aspects of the present invention.

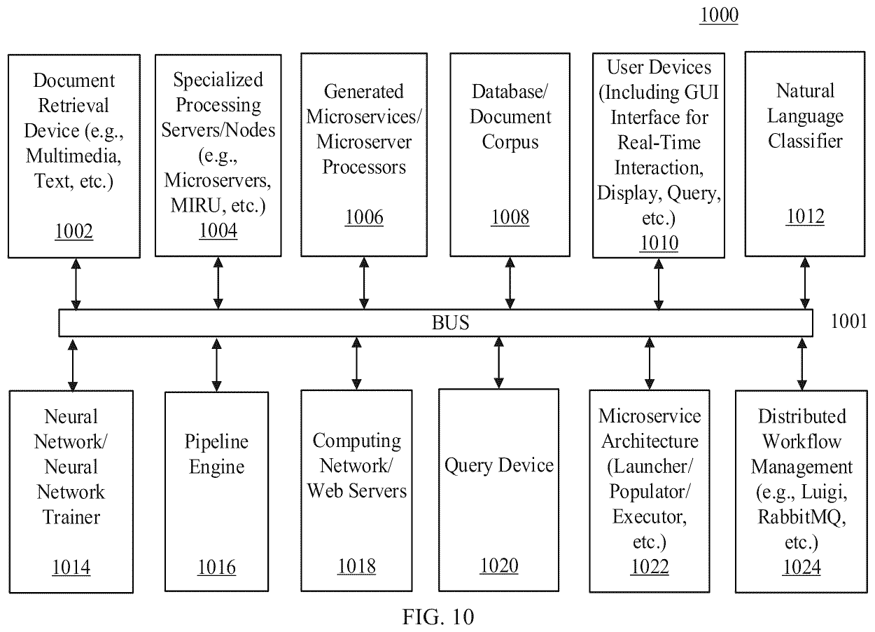

Referring now to FIG. 10, a diagram showing a system 1000 for dynamically initializing, analyzing, and visualizing document corpuses in real-time through user-guided semantic classification and dynamic feedback integration for optimized interactive document analysis, processing, and exploration, is illustratively depicted in accordance with embodiments of the present invention.

In various embodiments, document retrieval device 1002 can be utilized to collect and/or receive one or more documents (e.g., multimedia, text, visual, etc.) as input for analysis and processing. The document retrieval device 1002 can serve as a multimodal data acquisition system, capable of collecting documents in various formats from different fields, including but not limited to legal, medical, scientific, and educational texts. Its versatility allows for the processing of industry-specific data formats, enabling the system to cater to a wide range of professional needs. In block 1004, specialized processing servers or nodes represent a suite of microservers, each engineered to handle particular types of data and computational tasks. These nodes preprocess the input documents, normalizing formats, extracting relevant data features, and ensuring consistency across different document types, from research papers to technical manuals.

In various embodiments, the specialized processing servers or nodes 1004 can include a sophisticated array of computational resources tailored to perform deep semantic analysis of data. These servers or nodes are equipped with state-of-the-art machine learning (ML) algorithms capable of preprocessing vast quantities of documents to extract meaningful relationships and semantic information. The data processed by these servers is not limited to a single dimension or metric; instead, the system is adept at arranging and interpreting results in multi-dimensional space, enabling a more holistic understanding of the document corpus.

In some embodiments, the servers or nodes 1004 can operate on the principle of multimodal data representation, encompassing text, images, PDFs, tables, structured data like graphs, and machine learning representations, including word vectors and embeddings. They can dynamically generate data representations on demand and in reaction to user interactions, significantly supporting decision-making processes. Whether it's through visualizing complex data clusters, discovering relational insights between different data points, or enabling active learning and search, these specialized processing servers provide a platform for interactive data engagement, in accordance with aspects of the present invention.

Furthermore, these servers or nodes can facilitate productive and creative activities by allowing users to interact directly with data structures that encapsulate the essence of a collection of documents. This interaction is not a passive retrieval but a proactive engagement, wherein users can drag points, apply constraints, re-embed, and customize data spaces within the ML model, thereby reshaping the semantic understanding to fit specific user requirements. As the core of the system's architecture, specialized processing servers or nodes 1004 can work in concert with micro-services, connected through a message broker that allows modular full-stack development. They offer a flexible and distributed deployment that can be local or network-connected, thus supporting real-time, interactive web applications. This makes the servers capable of integrating research outputs from diverse fields and facilitating collaboration at scale across various departments within an organization, in accordance with aspects of the present invention.

In block 1006, dynamic microservices can be instantiated as modular processing units. They conduct domain-specific analyses, such as identifying key research findings within scientific papers or extracting procedural steps from technical guides, demonstrating adaptability to the diverse nature of document corpuses. In block 1008, the system's database houses a comprehensive document corpus with robust indexing to accommodate multifaceted queries. The structure of this database is sophisticated enough to manage the nuances of various document types, supporting swift data retrieval across multiple domains. One or more user devices 1010 (e.g., smartphone, tablet, laptop, desktop, etc.) with advanced, customizable GUIs enable professionals from any field to interact with the system in real-time. These interfaces are designed to be intuitive, allowing for seamless navigation and manipulation of data visualizations, irrespective of the user's technical expertise.

In various embodiments, a natural language classifier 1012 can be powered by domain-agnostic algorithms to analyze text within documents and classify them based on the semantic features relevant to the user's queries, regardless of the document's field of origin. In block 1014, neural network models and trainers represent the system's learning core, which is designed to adapt to the varied complexities of documents across domains. These models leverage user interactions to refine their understanding and improve the accuracy of document classification and feature extraction processes. In block 1016, a pipeline engine meticulously sequences data transformations and analysis tasks, ensuring that documents from disparate domains are processed efficiently and accurately. It acts as the orchestrator of data flow, allowing the system to remain agile and scalable. In block 1018, a robust computing network and associated web servers form the hardware foundation that enables distributed computing and provides the backbone for web-based access for application to a diverse user base with different document analysis needs.

In various embodiments, a dedicated query device 1020 serves as the gateway for processing user queries, capable of interpreting complex inquiries across various fields, from medical diagnosis queries to legal precedent searches. A microservice architecture framework 1022 enables the on-demand launching, populating, and execution of microservices, ensuring seamless service deployment and management within a multi-domain analysis system.

In block 1024, distributed workflow management components (e.g., Luigi, RabbitMQ, etc.) provide the infrastructure necessary to manage and coordinate an intricate network of microservices. They ensure the efficient handling of diverse workflows and maintain seamless communication across the system's services, and manage the workflows and communication between different services. These tools allow for the distribution of processing tasks across various services and ensure that all components of the MIRU system work in harmony. Bus 1001 is the central data bus that interlinks the system's components. It facilitates the high-speed transmission of data, instructions, and results throughout the system, ensuring that different modules can communicate and collaborate in real-time, in accordance with aspects of the present invention.

The system 1000 provides a comprehensive environment for processing and analyzing large volumes of documents based on user-defined criteria, with an interactive interface that adapts to the users' analysis needs. The system is designed to be flexible, scalable, and responsive, utilizing a micro-service architecture that allows for dynamic interactions and on-demand generation of machine learning representations, in accordance with aspects of the present invention.

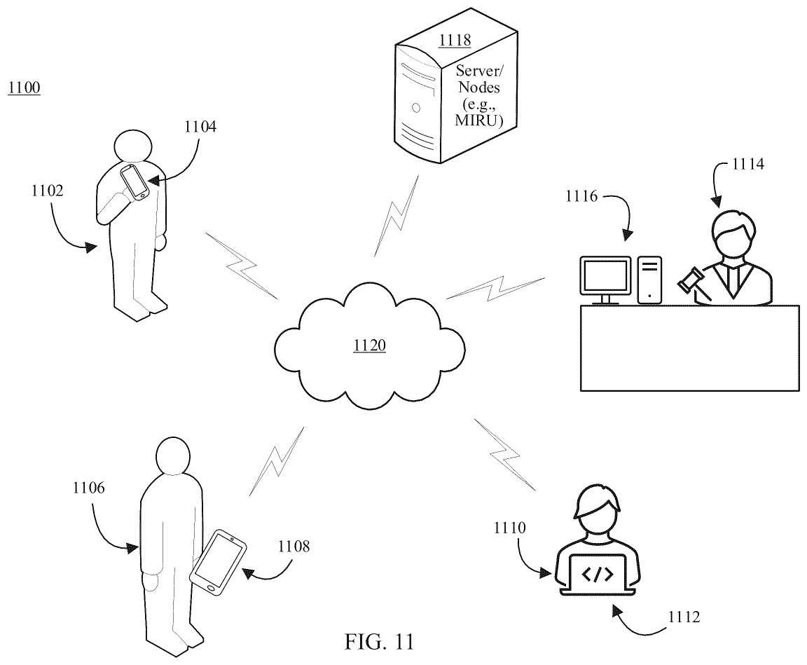

Referring now to FIG. 11, a diagram showing a system and method 1100 for dynamically initializing, analyzing, and visualizing document corpuses in real-time in a courtroom environment through user-guided semantic classification and dynamic feedback integration for optimized interactive document analysis, processing, and exploration, is illustratively depicted in accordance with embodiments of the present invention.

In various embodiments, a courtroom can be transformed into a technological hub where each participant is equipped with devices that access a centralized document analysis system (e.g., MIRU system architecture). This setup represents the digitization of legal proceedings, aiming to streamline workflows, facilitate evidence presentation, and enhance case analysis through advanced computing solutions. As an illustrative example, a defense attorney 1102 can use a smartphone 1104 to interact with the MIRU system. Through this device, the attorney can quickly upload new evidence, access case-related documents, or input semantic queries to retrieve relevant case law or precedents. Real-time updates to the case file or new findings are immediately synchronized with the central server 1118, ensuring that the latest information is accessible to all authorized courtroom participants.

A prosecutor 1106, shown utilizing a tablet 1108, can use a touch interface to navigate through the MIRU system's database. The tablet's larger screen offers an expansive visual interface, allowing the prosecutor to engage with interactive data visualizations that represent complex case relationships or document embeddings. This can include sorting through documents by semantic relevance or examining the intricacies of case facts through a user-friendly GUI. A judge 1114, shown seated at the bench and operating a desktop computer 1116 can oversee the court proceedings with direct access to an extensive repository of legal documents, analytic tools, and case histories stored within the MIRU system. The judge's desktop is a terminal through which complex algorithms summarize case facts, identify patterns in legal outcomes, and present synthesized information to support judicial decisions. A court clerk 1112, shown using a laptop 1112 to interact with the server 1118, manages the documentation flow, ensuring the administrative aspects of the trial are digitally captured and integrated into the MIRU system. The laptop connects to the network 1120, facilitating the real-time recording of testimonies, evidence submissions, procedural developments, and updated sentencing guidelines. It can act as a gateway for maintaining the court's official record in digital format, accessible instantaneously by the legal teams and the judiciary.

In various embodiments, a network (e.g., cloud, Internet, LAN, WAN, etc.) represents a connectivity layer that can be utilized to connect all devices, enabling seamless communication and data exchange. It is the backbone of the MIRU system, providing the infrastructure for cloud computing, data storage, and online collaboration. This server 1118 is the powerhouse of the MIRU system, where data can be quickly and efficiently processed, analyzed, and stored. It hosts the machine learning models that parse and understand legal language and create microservers, drawing implications from the text and facilitating semantic search capabilities. This is where the system's neural network can reside, continuously learning from new data inputs, user feedback, and evolving legal criteria, in accordance with aspects of the present invention.

In various embodiments, the devices 1104, 1108, 1112, 1116 can interact with the server 1118 over the network 1120 in various ways. For instance, the attorney's smartphone 1104 may send a request to retrieve similar case laws based on a semantic feature, such as “evidence suppression due to procedural violations.” The server processes this request, querying its vast database of legal documents and returning relevant cases ranked by semantic similarity. The prosecutor's tablet 1108 might display these cases, allowing the prosecutor to examine each case's details, filter by outcomes, or even suggest edits or additions to the database in real-time. At the core of the server 1118, advanced NLP algorithms classify and tag documents, extract features, and learn from interaction patterns. This intelligent processing enables the system to provide predictive insights, like potential legal strategies based on historical data trends or to flag documents that warrant closer scrutiny due to their semantic content. As the courtroom proceedings continue, the flow of data is dynamic and bidirectional. Queries from the user devices prompt real-time data retrieval and visualization, while inputs and feedback from the users are fed back into the system, refining the models and representations. This creates a feedback loop, continuously enhancing the system's accuracy and relevance to the current case.

In various embodiments, the server 1118 can serve as a technological cornerstone of the courtroom, enabling an intelligent and responsive legal analysis system that fundamentally transforms sentencing deliberations and procedures. The server 1118 operates as the analytical brain of the courtroom's digital environment. It's equipped with robust data processing capabilities, high-speed computational power, and advanced machine learning models that specialize in Natural Language Processing (NLP) and semantic analysis. For sentencing, it houses a comprehensive database of historical sentencing data, legal precedents, statutory guidelines, and real-time court proceeding records. The server 1118 can assist the judge 1114 by providing a data-driven foundation for sentencing decisions. It analyzes the current case's details against vast historical data, highlighting precedent cases with similar circumstances and their outcomes. For instance, when the judge inputs factors such as the severity of the offense, defendant's background, and case specifics, the server processes this information, leveraging its NLP capabilities to understand the context and nuances within the legal documents.

The server 1118 can apply predictive modeling to suggest sentencing guidelines that align with historical patterns while considering legal constraints and judicial discretion. It can present the judge with a range of sentencing scenarios, each backed by data and precedent, along with an interactive interface on the desktop computer 1116 for fine-tuning the criteria or exploring “what-if” simulations. These insights are crucial in assisting the judge to determine a fair and equitable sentence, grounded in a deep understanding of legal precedents and the nuances of the current case. For the Defense Attorney 1102 and Prosecutor 1106: Both parties can leverage the MIRU server's real-time query capabilities to receive instant, data-backed sentencing guidelines. By using their respective devices (e.g., a smartphone 1104 for the defense attorney 1102 and a tablet 1108 for the prosecutor 1106), they can submit queries through a user-friendly GUI interface about specific case features or precedents related to sentencing and receive near-instantaneous responses from the server 1118 fulfilling their request, in accordance with aspects of the present invention.

In some embodiments, a user can input to the server 1118 a set of English language (or other languages) hypotheses, declaring high-level hypotheses relevant to sentencing an individual (e.g., “The defendant is in poverty”). An active learning web interface can be utilized for finetuning a transformer model to find sentences that may require more labeling, present them to a user for providing feedback, and fine tune the transformer model with the given feedback. Using the hypotheses, features for all cases can be generated and embedded, in addition to metrics being generated and classifiers being trained, in accordance with aspects of the present invention.

In this exemplary courtroom environment, the server 1118 processes these queries through its semantic search engine, retrieving information from its extensive legal databases. It can provide comparative analytics on sentencing outcomes for cases with similar legal features or demographic data of defendants. For example, the defense attorney can query for cases where leniency was granted under certain conditions, while the prosecutor can seek instances of stricter sentencing for particular offenses. The server 1118 can customize these guidelines based on the unique query parameters set by the attorney or prosecutor (or other users), ensuring that each receives tailored information to aid in their case strategy. It delivers this customized data as interactive visualizations on their devices, enabling them to quickly grasp complex information, which can be important to obtain in real-time (e.g., during negotiations or sentencing hearings). The server 1118 interweaves advanced computational techniques with judicial processes, offering an unprecedented level of analytical depth and real-time responsiveness. This helps ensure that sentencing is not only consistent with legal standards and past judgments but also responsive to the unique complexities of each case, providing a more nuanced and just legal process, in accordance with aspects of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for analyzing document corpuses, the method comprising:
initializing a Natural Language Inference (NLI) classification model pre-trained on a diverse linguistic dataset;
analyzing a corpus of textual documents with a plurality of semantic features described in natural language by a user;
executing, for each of the semantic features, a classification process using the NLI model to assess implication strength between sentences in the documents and the semantic features, the classification process including a confidence scoring mechanism to quantify implication strength;
aggregating, for each of the documents, implication scores across all the semantic features to form a composite semantic implication profile;
applying a dimensionality reduction technique to the composite semantic implication profiles of each of the documents to generate a two-dimensional semantic space representation; and
dynamically adjusting the two-dimensional semantic space representation based on iterative user feedback regarding an accuracy of semantic implication assessments.

2. The method of claim 1, and a debugged NLI model is generated based on a fast few-shot learning process incorporating the user feedback which includes conducting preliminary fine tuning from an initial pre-trained NLI model with a debugging set derived from the user feedback to adjust model parameters, and identifying examples misclassified by a preliminary finetuned NLI model but correctly classified by the initial NLI model to form a targeted set for combining with the debugging set for additional finetuning from the initial NLI parameters to yield the debugged NLI model.

3. The method of claim 1, further comprising preprocessing the corpus of textual documents for noise reduction, the preprocessing including removing non-textual elements, normalizing textual formats, and tokenizing sentences.

4. The method of claim 1, further comprising generating a graphical user interface (GUI) that displays the two-dimensional semantic space representation, wherein individual documents are represented as selectable nodes within the GUI, enabling users to explore document relationships intuitively.

5. The method of claim 1, wherein the iterative user feedback includes graphical manipulation of document positions within the two-dimensional semantic space representation, and being used to refine the classification process by adjusting implication strength scoring based on a rearrangement of documents by the user to enable a user-driven approach to semantic feature analysis and visualization.

6. The method of claim 5, wherein a graphical user interface (GUI) provides functionality for users for manually repositioning documents within the two-dimensional semantic space, with the repositioning being utilized as additional user feedback for model refinement.

7. The method of claim 1, further comprising validating the classification process by presenting selected sentences with high confidence scores and sentences near a confidence threshold to the user, wherein the user confirms or corrects the implications assessed by the NLI model, thereby enhancing the accuracy of the composite semantic implication profiles for subsequent iterations of the method.

8. A system for analyzing document corpuses for interactive, on-demand generation of machine learning representations within a web browser environment, comprising:
a processor device operatively coupled to a computer-readable storage medium, the processor executing instructions for:
activating a data processing pipeline designed to accept raw input data, including text and images, applying a series of machine learning-based transformations to generate vectorial representations of the data, and preprocessing the data through normalization, tokenization, and feature extraction processes;
instantiating and managing a plurality of data-centric micro-services, each micro-service dedicated to a distinct dataset or data type, including maintaining and manipulating in-memory representations of transformed data, and exposing a queryable application programming interface (API) for real-time data interaction and retrieval;
creating user session models through user-centric threads, each thread capturing and responding to individual user interactions, feedback, and navigation patterns within the system to offer a tailored data exploration and manipulation experience; and
provisioning a dynamic user interface, rendered within the web browser, to visualize machine learning representations, including document embeddings and statistical data models to enable direct manipulation of the representations by the user, and capture user feedback for iterative model refinement.

9. The system of claim 8, wherein the data processing pipeline further includes instructions for implementing Natural Language Processing (NLP) algorithms to enhance text data transformations, facilitating deeper semantic analysis and feature extraction for improved representation accuracy.

10. The system of claim 8, wherein each data-centric micro-service dynamically adjusts its operational parameters, including a selection of machine learning models and algorithms, based on specific requirements of the dataset or data type it is dedicated to, ensuring optimal data representation fidelity.

11. The system of claim 8, further comprising instructions for integrating a feedback loop mechanism within the user interface, enabling users to submit qualitative and quantitative feedback on an accuracy, relevance, and utility of the machine learning representations, with the system aggregating and applying the feedback to adjust and retrain underlying machine learning models in real-time.

12. The system of claim 11, wherein the feedback loop mechanism includes tools for visually repositioning elements within embeddings displayed on the user interface, with each repositioning action translated into specific feedback signals for model retraining purposes.

13. The system of claim 8, further comprising a graphical user interface (GUI) that displays a two-dimensional semantic space representation, wherein individual documents are represented as selectable nodes within the GUI, enabling users to explore document relationships intuitively, the iterative user feedback including graphical manipulation of document positions within the two-dimensional semantic space representation, and being used to refine a classification process by adjusting implication strength scoring based on a rearrangement of documents by the user to enable a user-driven approach to semantic feature analysis and visualization.

14. The system of claim 8, further comprising instructions for enabling collaborative data exploration sessions, wherein multiple users can interact with a same machine learning representation simultaneously, share feedback, and observe real-time adjustments to the representations based on collective user inputs.

15. A computer program product for analyzing document corpuses for interactive, on-demand generation of machine learning representations within a web browser environment, the computer program product comprising a computer readable storage medium having program instructions embodied therewith, the program instructions executable by a hardware processor to cause the hardware processor to:
initialize a Natural Language Inference (NLI) classification model pre-trained on a diverse linguistic dataset;
analyze a corpus of textual documents with a plurality of semantic features described in natural language by a user;
execute, for each of the semantic features, a classification process using the NLI model to assess implication strength between sentences in the documents and the semantic features, the classification process including a confidence scoring mechanism to quantify implication strength;
aggregate, for each of the documents, implication scores across all the semantic features to form a composite semantic implication profile;
apply a dimensionality reduction technique to the composite semantic implication profiles of each of the documents to generate a two-dimensional semantic space representation; and
dynamically adjust the two-dimensional semantic space representation based on iterative user feedback regarding an accuracy of semantic implication assessments.

16. The computer program product of claim 15, wherein the user feedback includes indications of correct and incorrect semantic implications, the dimensionality reduction technique being Uniform Manifold Approximation and Projection (UMAP).

17. The computer program product of claim 15, further comprising preprocessing the corpus of textual documents for noise reduction, the preprocessing including removing non-textual elements, normalizing textual formats, and tokenizing sentences.

18. The computer program product of claim 15, further comprising generating a graphical user interface (GUI) that displays the two-dimensional semantic space representation, wherein individual documents are represented as selectable nodes within the GUI, enabling users to explore document relationships intuitively.

19. The computer program product of claim 15, wherein the iterative user feedback includes graphical manipulation of document positions within the two-dimensional semantic space representation, and being used to refine the classification process by adjusting implication strength scoring based on a rearrangement of documents by the user to enable a user-driven approach to semantic feature analysis and visualization.

20. The computer program product of claim 15, further comprising validating the classification process by presenting selected sentences with high confidence scores and sentences near a confidence threshold to the user, wherein the user confirms or corrects the implications assessed by the NLI model, thereby enhancing the accuracy of the composite semantic implication profiles for subsequent iterations.
